(19) United States
(12) Patent Application Publication
(10) Pub. No.: US 2004/0225055 A1
(43) Pub. Date: Nov. 11, 2004

(54) Cleaning process involving a dissolvable polymer coating

(76) Inventors: Hans Haas, Stow, OH (US); Marcia Snyder, Stow, OH (US)

Correspondence Address: Gifford, Krass, Groh, Sprinkle,, Anderson & Citkowski, P.C., Suite 400, 280 N. Old Woodward Avenue, Birmingham, MI, 48009, US

(21) Appl. No.: 10/839,375

(22) Filed: May 5, 2004

Related U.S. Application Data
(60) Provisional application No. 60/468,297, filed on May 6, 2003.

(51) Int. Cl. B08B 7/00; C08K 3/00

(52) U.S. Cl. 524/556; 134/6; 523/122

(57) ABSTRACT

A composition and process are provided to provide a protective sacrificial film on a substrate. The sacrificial protective film collects environmental contaminants and is removed by application of a solution having a pH greater than 9.0. The protective film is formed by coating the substrate with a polymer having acidic moieties that have been neutralized with a base. A contaminated protective film is readily dissolved by a reapplication of an aqueous dispersion containing the neutralized coating polymer.

### RELATED APPLICATION

This application claims priority of U.S. Provisional Patent Application Ser. No. 60/468,297 filed May 6, 2003, which is incorporated herein by reference.

### FIELD OF THE INVENTION

The present invention generally relates to surface cleaning, and in particular to dissolving a sacrificial polymeric coating to affect surface cleaning.

### BACKGROUND OF THE INVENTION

Surface weathering of vehicle exterior surfaces has deleterious effects on vehicle performance and appearance. Surface weathering is a process that can be traced to abrasion of vehicle exterior surfaces by inorganic particulates such as sand and brake dust. Ironically, the process of cleaning a vehicle exterior with brushes or high velocity water jets serves to create micro abrasions in vehicle painted surfaces and wheel covers that facilitate further collection of particulate and environmental photochemical and electrochemical surface degradation reactions.

It is conventional to the art to maintain the finish of new vehicle exterior surfaces by the application of polymeric films thereto. The application of plastic sheeting is labor intensive and impractical to retain on a vehicle in actual service. Alternatively, emulsion coating materials are applied from solutions which dry to form peelable coatings. Illustrative of such peelable coatings are latex emulsions conventional to paint formulations and those detailed in U.S. Pat. No. 6,124,044. However, emulsion based coatings have met with limited acceptance owing to labor involved in peeling such a protective coating from a vehicle exterior surface, especially those such as wheels that have intricate structures. Thus, there exists a need for a solution applied protective coating for vehicle exterior surfaces that is redissolvable and thus removable without manual contact with the vehicle surface.

### SUMMARY OF THE INVENTION

A cleaning composition is described that functions as a sacrificial protective film and includes an aqueous dispersion made up of a coating polymer having acidic moieties that have been neutralized with a base. The coating polymer forms a protective film upon drying that is redissolvable in a solution having a pH greater than 9.0. As a process for keeping a substrate clean, the substrate is coated with a base neutralized acidic polymer dispersed in aqueous solution. With the evaporation of the solution a protective polymeric film is formed, the surface of which collects environmental contamination. The substrate is cleaned by dissolving the polymeric film to yield a substrate of precoating cleanliness. Dissolution of a soiled polymeric film is readily performed by reapplication of the polymer dispersed in the aqueous solution with subsequent rinsing of the substrate and reapplication of the coating polymer again affords a protected substrate.

### DESCRIPTION OF THE PREFERRED EMBODIMENTS

The present invention has utility as a protective coating for a substrate. While the present invention is described with respect to the substrate being a vehicle exterior surface and more preferably a vehicle wheel cover, it is appreciated that the inventive materials and processes are equally applicable to vehicle and building windows, building siding, concrete, ceramics, marine structures, lumber products and fabrics. An inventive process includes the step of coating a substrate such as a vehicle wheel with a water dispersed coating product and allowing the aqueous dispersed product to dry to form a protective film. The coated substrate is then put into service. Upon the substrate being sufficiently fouled to warrant cleaning, the same water dispersed coating product is applied over the existing protective film and allowed to remain in contact with the protective film for a sufficient amount of time to redissolve the film. The redissolved film is removed with water rinsing to yield a substrate restored to a precoating state of cleanliness independent of scrubbing or mechanical peeling of the protective film from the substrate. The substrate is then optionally recoated with the water dispersed coating solution and allowed to dry to reform the inventive protective film. An inventive water dispersed coating composition produces a film with adherence to the substrate. Preferably, the film has a limited number of pinholes therein. More preferably, an inventive film dries to a clear and tackless layer. As used herein, “tackless” is defined as the condition when the layer has hardened to a point that the surface can be touched lightly to a weight of 5 grams/centimeter squared without a sensation of stickiness.

An inventive water dispersed coating composition includes polymeric emulsion- or latex-containing acidic moieties that have been neutralized with a base. Polymers operative within a water dispersed coating composition include polyacrylates, such as linear or branched polyacrylate, vinyl-acrylate copolymers, polyglycolates, polyacetates, copolymers and combinations thereof. Preferably, the polymer is a thermoplastic linear polyacrylate latex. An inventive polymer is neutralized with a base that yields a redissolvable dried film that approaches attainment of the above-described preferred properties. While it is appreciated that the nature of the base cation suitable to achieve a redissolvable protective film is dependent on the nature of the polymer, some suitable bases illustratively include sodium hydroxide, potassium hydroxide, calcium hydroxide, ammonium hydroxide, tetraalkyl ammonium hydroxide, N-alkyl pyridinium hydroxide, pyridine, primary, secondary and tertiary amines, alkyl phosphonium hydroxide and amidozolium hydroxide. In the instance where the inventive polymer is a linear polyacrylate latex, ammonium hydroxide is the preferred base. Generally, polyatomic base cations are preferred in order to produce protective films that are redissolvable and approach attainment of optimal film properties as detailed above with respect to being tackless. In a preferred embodiment, the acidic polymer and neutralizing base are biodegradable. The resulting neutralized polymer is formulated as a latex or emulsion through the addition of conventional components and processing techniques. In practice, numerous acidic polymer latexes and emulsions are commercially available illustratively including Rohm & Haas Rhoplex®, Noveon Carboset® and Avalure®AC, Dow Chemical Ucar®, Eastman Aquamac® and Hydreau® acrylic latex polymers. Preferably, an inventive aqueous dispersed coating composition has a pH of between 9.3 and 11 in order to preclude caustic damage to an underlying wheel or other substrate.

In addition to the inventive film forming polymer, a water dispersed coating composition according to the present invention optionally includes a variety of other additives illustratively including algaecides, fungicides, antioxidants, pigments, dyes, surfactants, corrosion inhibitors, ultraviolet light stabilizers, cosolvents, antistatic agents, plasticizers, fragrances, dyes, pigments, antifoaming agents, corrosion inhibitors and thickeners.

A typical inventive water dispersed coating composition contains 5 to 70 weight percent of neutralized film forming polymer. Preferably, an inventive composition contains from 5 to 30 weight percent film forming polymer. Optional additives such as algaecides, fungicides, antioxidants and ultraviolet light stabilizers are each typically present from 0.01 to 5 weight percent, and preferably from 0.05 to 1.0 weight percent, and most preferably from 0.1 to 0.5 weight percent of the total hydrated composition. Other optional additives such as cosolvents, plasticizers, fragrances, dyes, pigments, antifoaming agents, corrosion inhibitors and thickeners are each typically present from 1 to 20 weight percent, more preferably from 0.05 to 5 weight percent and most preferably from 0.1 to 5 weight percent based on the total hydrated composition weight.

An antistatic agent is a preferred additive that lessens electrostatic contaminant acceleration on an inventive coating. Antistatic agents operative herein are those common to the art for polymeric coatings and illustratively include alkoxylated amines such as C₅-C₂₅ ethoxylated amines and glycerol fatty acids such as glycerol monostearate. Alkoxylated amines are typically present from 0.05-5 weight percent and preferably from 0.065 to 0.15 weight percent. Glycerol fatty acids are typically present from 0.05 to 5 weight percent and preferably from 0.1 to 1.5 weight percent.

An inventive water dispersed coating composition is applied to a substrate by methods convention to the art illustratively including application by spray, brush, roller, sponge or immersion. An inventive coating composition is readily packaged as an aerosol spray pressured with a conventional propellant or in a spray bottle dispenser such as a hand-pumped dispenser with an atomizer nozzle. An inventive coating composition is air dried under temperature and humidity conditions suitable for water evaporation. It is appreciated that drying time for an inventive composition is reduced through increased temperature and/or reduced humidity obtained through the use of a heat gun or other conventional blower and/or heater device. Removal of a protective film obtained by drying a coating composition on a substrate is achieved by exposing a protective film to a solution having a pH of greater than about 9.0. While it is appreciated that an inventive protective film is removed by any such basic pH solution, in a preferred embodiment the protective film removal solution is the water dispersed coating composition itself. After contact time typically ranging from 15 seconds to 5 minutes between a reapplied solvated coating composition and a protective film, both are removed by a water wash. Typically, no scrubbing, peeling or other mechanical ablation is required to remove the protective film. A dried substrate is then immediately prepared for reapplication of the inventive water dispersed coating composition so as to form a new protective film.

### EXAMPLES

### Example 1

38.11 grams acrylic colloidal dispersion (Carboset 514H manufactured by Noveon) is dispersed in 57.67 grams water. 2.06 grams ethylene glycol monobutyl ether is added along with 0.1 grams of a polyol based defoamer (Foamblast 327 manufactured by Lubrizol Foam Control Additives). 2.06 grams of a 28% by weight aqueous solution of ammonium hydroxide is added to produce an inventive cleaning composition.

### Example 2

The composition of claim 1 was sprayed as an aerosol onto an aluminum panel and allowed to dry as a tackless film. Various cleaning solutions with a pH lower than that of the inventive solution composition are tested. A cleaning solution is sprayed onto the aluminum panel having an inventive composition film thereon. A timer is started as soon as cleaner is sprayed onto the panel. The cleaner is allowed to remain in contact with the panel for 30 seconds and then rinsed for approximately 25 seconds under cold tap water. The panel is patted dry with a paper towel and the film characteristics observed as shown in Table 1.

TABLE 1
Film Stability as a Function of Cleaner pH

| Cleaner | pH | Observation |
|---|---|---|
| Simple Green ® | | |
| full strength | 9.65 | removes film |
| 10 water by volume: 1 cleaner | 9.46 | partially removes film |
| 20 water by volume: 1 cleaner | 8.94 | softens film but does not |
| | | remove it |
| Simonize Car Wash ® | | |
| 20:1 | 7.55 | softens edges of film but does |
| | | not remove it at all |
| 50:1 | 7.53 | softens edges of film but does |
| | | not remove it at all |
| Orange Blast with citric acid | 5.49 | no effect on film |

### Example 3

The composition of Example 1 is applied to an aluminum panel to form a tackless film. In order to simulate the action of an automated car wash, Simonize car wish is diluted with 20 parts by volume water to 1 part by volume Simonize car wash and applied to the film coated aluminum panel with a spray gun operating at 40 pounds per square inch continuously for one minute. No degradation of the film on the aluminum panel is observed.

### Example 4

The composition of Example 1 is sprayed onto aluminum panels and allowed to dry as a tackless film. Thereafter, the tackless film is sprayed with more of the inventive composition of Example 1. A timer is started upon contact between the secondary spray of inventive composition with the aluminum panel film. The secondary spray of inventive composition according to Example 1 is allowed to remain in contact with the panel film for a time of either 10, 15 or 30 seconds. After spray contact with the coated panel, the panel is rinsed for approximately 25 seconds under cold tap water and blotted dry with a paper towel. The tackless film is completely removed in all three instances of spray contact time of 10, 15 or 30 seconds. The tackless film appears to dissolve instantly in a secondary spray application of inventive composition.

The present compositions and processes described herein representative of preferred embodiments are exemplary and are not intended to be limitations on the scope of the invention. Changes therein and other uses will occur to those skilled in the art which are encompassed within the spirit of the invention as defined by the scope of the appended claims.

1. A protective coating composition comprising:
an aqueous dispersion comprising a coating polymer having acidic moieties that have been neutralized with a base that forms a protective film upon drying, said protective film being redissolvable in a solution having a pH greater than 9.0.

2. The composition of claim 1 wherein said film is tackless.

3. The composition of claim 1 wherein said dispersion has a pH of between 9.3 and 11.

4. The composition of claim 1 wherein said base is selected from the group consisting of: ammonium hydroxide, tetraalkyl ammonium hydroxide, N-alkyl pyridinium hydroxide, pyridine, primary, secondary and tertiary amines, alkyl phosphonium hydroxide and amidozolium hydroxide.

5. The composition of claim 1 wherein said polymer is an emulsion or a latex.

6. The composition of claim 5 wherein said polymer is selected from the group consisting of: linear polyacrylates, branched polyacrylates, vinyl-acetate copolymers, polyglycolates, polyacetates, copolymers and combinations thereof.

7. The composition of claim 1 wherein said polymer is a thermoplastic linear polyacrylate latex.

8. The composition of claim 1 wherein said film is clear.

9. The composition of claim 7 wherein said base is ammonium hydroxide.

10. The composition of claim 1 wherein said polymer is present from 5 to 70 total weight percent.

11. The composition of claim 1 further comprising at least one additive selected from the group consisting of: a cosolvent, an algaecide, a fungicide, an antioxidant, a pigment, a fragrance, a plasticizer, a dye, a surfactant, a corrosion inhibitor, an ultraviolet light stabilizer, and a thickener.

12. The composition of claim 1 further comprising an antistatic agent.

13. A process for cleaning a substrate comprising the steps of:
coating said substrate with a base neutralized acidic polymer dispersed in an aqueous solution;
evaporating the aqueous solution to form a protective polymeric film;
exposing said polymeric film to a substrate contaminating environment; and
dissolving said polymeric film.

14. The process of claim 13 wherein said film is tackless.

15. The process of claim 13 wherein said aqueous solution has a pH greater than 9.5.

16. The process of claim 13 where dissolution of the polymeric film is independent of mechanical abrasion.

17. The process of claim 13 wherein said polymeric film is dissolved by said polymer dispersed in the aqueous solution.

18. The process of claim 13 wherein said polymeric film dissolves upon exposure to a pH of greater than 9.0.

19. The process of claim 13 further comprising the step of rinsing said substrate subsequent to dissolution of said polymeric film.

20. The process of claim 19 further comprising the step of recoating said substrate with said polymer dispersed in the aqueous solution.

21. The process of claim 13 wherein the substrate is a vehicle wheel.

22. The process of claim 13 wherein the substrate is selected from the group consisting of: a vehicle exterior surface, building windows, building siding, concrete, ceramics, marine structures, lumber products and fabrics.

23. The process of claim 13 wherein said substrate is coated with a device selected from the group consisting of a spray, a brush, a roller, and a sponge.

24. An improved process for cleaning a substrate including applying a solution based polymer to form a protective film on a substrate after the protective film has been exposed to an environmental contaminant removing the protective film wherein the improvement lies in: removing the protective film by reapplication of the aqueous coating composition from which the protective film was derived, the composition having a pH greater than 9.0 to redissolve the film independent of mechanical ablation.
